(19) United States
(12) Patent Application Publication
(10) Pub. No.: US 2010/0052329 A1
(43) Pub. Date: Mar. 4, 2010

(54) Air flow dynamo-selfbooster

(76) Inventor: Bereli M. Lazar, San Francisco, CA (US)

Correspondence Address: Bereli M. LAZAR, Apt 410s, 1590 Broadway, San Francisco, CA, 94109, US

(21) Appl. No.: 12/291,068

(22) Filed: Nov. 6, 2008

Related U.S. Application Data
(60) Provisional application No. 61/190,911, filed on Sep. 4, 2008.

(51) Int. Cl. F03D 9/00; F03B 17/04

(52) U.S. Cl. 290/55; 415/916

(57) ABSTRACT

The Air Flow Dynamo-Self-booster includes a method and means for obtaining energy in direct transfer from ionized, seeded, cyclical, intense operative air flow by electromagnetic induction inside a closed loop tunnel.

The structure comprises:
a multi-stage axial fan, and a compensative seal compressor,
a combined set of electrostatic ionizers, seeding and humidifying units,
an array of electromagnetic inductors, thermopile coolers,
a set of electrodes, power units, thermostat, meters.

The fan works in self-series, in self-boosting and accumulative manner, cyclically rising the operative air flow pressure with periodic compensation.

The powerful, intense, ionized operative air flow provides induction and feeding to the electrodes with induced energy for output and self-supply.

The average power ratios take 4.0±25%, depending on design.

### RELATED APPLICATION

PPA No:61/190,911, filed Sep. 4, 2008 by present author.

### FEDERALLY SPONSORED RESEARCH

Not applicable.

### SEQUENCE LISTING OR PROGRAM

Not applicable.

### BACKGROUND OF THE INVENTION

This proposal relates to the devices of electromagnetic inductive energy transfer from electro-statically ionized, seeded, intense air flow to the collecting electrode-structure for energy output and self-supply.

The subject matter is a method and means for energy transfer by electromagnetic interactions between an array of inductors and operative seeded ionized, intense air flow inside a closed loop tubular tunnel with high energy ratio.

Some patented Prior Arts are represented in the classes 310, 320 of the US Classification System:
a) U.S. Pat. No. 5,883,448 “Gas-cooled electric machine” by H.Zimmerman includes an electro-inductive rotor with plurality of chambers for hot gases;
b) U.S. Pat. No. 6,181,046 B1 “Dynamo-electric machine . . . ” by A.Daikoku; Includes a rotor having a commutator with plurality of segments;
c) U.S. Pat. No. 5,886,433 “Dynamoelectric machine” by H. Oda et al.;
d) U.S. Pat. No. 5,895,994 “Dynamoelectric machine” by D. Molnar;
e) U.S. Pat. No. 6,181,045 B1 “Alternator for vehicle” by A. Umeda et al.;
f) U.S. Pat. No. 6,177,746 B1 “Low inductance electrical machine” by C. Tupper and D. Wood;
g) U.S. Pat. No. 6,172,434 B1 “Automotive alternator” by A. Ookashi;
h) U.S. Pat. No. 6,169,344 B1 “Alternating . . . generator . . . ” by K. Tsruhara.

Said above prior arts are based on modified electromechanical devices with rotors and other moving parts working in non-self-accumulating manner.

My proposal develops further the self-boosting technology of the testing closed wind tunnels (energy ratios are near 9.0) with a method of inductive electromagnetic energy transfer from the operative ionized intense air flow.

### BRIEF SUMMARY OF THE INVENTION

The objects of this proposal:
a) to develop a dynamic method and means for inductive transfer energy from an operative ionized intense air flow inside tubular closed loop tunnel,
b) to develop a combined set of devices for electrostatic ionizing, mix seeding with optional humidifying in order to reach appropriate electro-conductivity and magnetic permittivity for said ionized air flow,
c) to use an array of electromagnets integrated into said tunnel for inductive interactions with the operative air flow; to use proper static coolers,
d) to use an electrode structure for collecting the induced electric currents from the ionized intense air flow inside said tunnel,
e) to develop a self-boosting method of pressure-energy accumulation by self-series work of air flow impeller, and appropriate compensation to the compacted portions of operative intense air flow,
g) to provide effective energy output and self-supply with usage proper transformers, a battery block with a charger, and electric infrastructure.

The nature and substance of the Air Flow Dynamo-Self booster are:
A. A vane-axial multistage fan, installed in self-series, and cyclically propelling the operative air flow inside tubular closed loop tunnel,
B. A rotary seal slide-vane compressor for periodic compensating to the compacted portions of operative intense air flow inside said tunnel; valves,
C. A combined set of preparing devices which includes:
   the pulse-electrostatic ionizers with their feeding units, and
   the mix grit-powder seeding unit, and an optional humidifier, all said above-to provide the proper electro-conductivity and magnetic permittivity for said operative intense air flow,
D. An array of inductors for pulse-magnetic fluxes exciting, feeding units,
E. Thermopile coolers for electromagnetic inductors, and for air flow,
F. Noise-absorption unit, G. Electrode structure for collecting the induced electric currents in ionized and seeded operative air flow; meters,
H. Self-boosting method where fan impeller works at itself and for itself in pressure-energy accumulating manner with compressed air compensation,
I. Energy self-supply block, output transformer, electric infrastructure.

### DRAWING FIGURES

In the drawings, closely related elements have the same number but different alphabetic suffixes; numbers of views and sections correspond to the numbers of figures where they are shown.

FIG. 1 shows a side view of the Dynamo-self-booster with local exposures.

FIG. 2 is a plan view taken in FIG. 1.

FIG. 3 is a cross-section taken in FIG. 1.

FIG. 4 is an electromechanical scheme of the air flow thermopile cooler.

FIG. 5 illustrates a schematic section taken in FIG. 1, and integrated with a scanned functional electro-technological scheme of the Dynamo-self-booster.

FIG. 6 is a schematic cross-section taken in FIG. 1. FIG. 7 is a table of data.

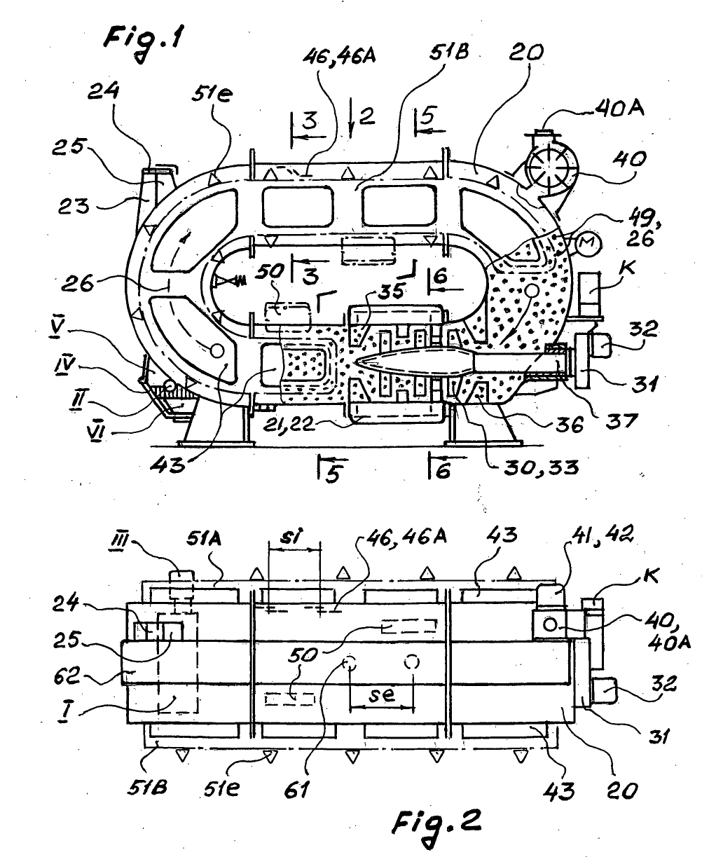

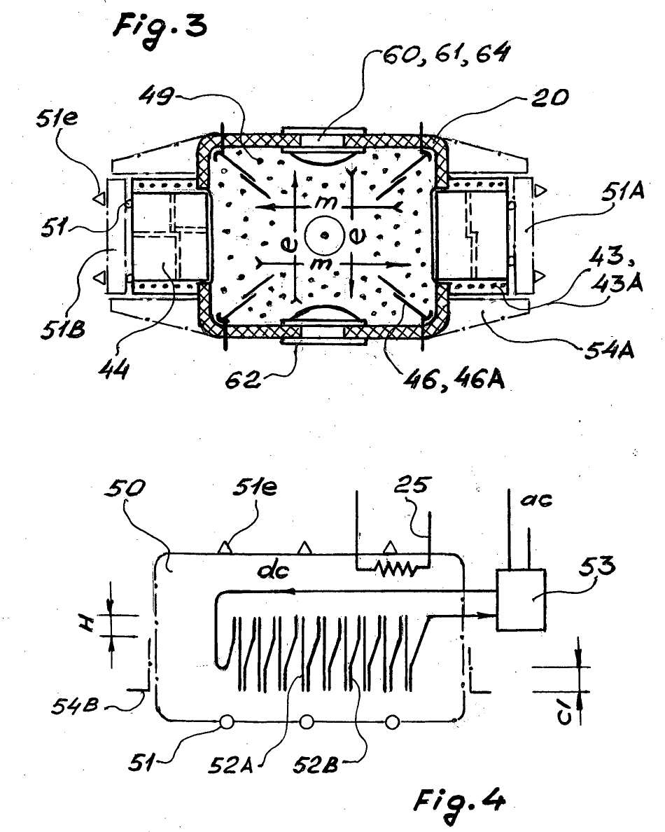

### REFERENCE NUMERALS AND SYMBOLS

20—oval closed loop tunnel
21—impeller housing
22—noise absorption unit
23—mix-seed supply unit
24—seed filter
25—thermostat
26—operative air flow
30—multi-stage vane-axial fan
31—fan drive
32—fan electric motor
33—fan blade
34—static vane
35—down stream guide
36—up stream guide
37—fan shaft-rotor
38—rotor bearing
40—slide-vane seal compressor
40A—intake filter
41—compressor's electric motor
42—compressor drive
43—inductor
43A—solenoid
44—inductor core
45—inductors' oscillator
46—electrostatic ionizer
46A—needle
47—ionizers' oscillator
48—diode
49—suspended mix-seed
50—thermopile air flow cooler
51—cold gill
51A, 51B—thermopile inductors' coolers
51e—hot gill
52A, 52B—semi-conductors
53—electric converter
54A, 54B—fixers
Electrode structure: 60—plate,
61—nib,
62—bar,
63—output transformer,
64—tie.
70—electric battery
71—rectifier
72—charger

Optional operation unit: I—humidifier, II—revolving screen, III—electric motor, IV—wetter, V—tray, VI—salt water. [symbol] operative air flow, [symbol] exciting magnetic flux, [symbol] induced electric current, [symbol] suspended mix seed, [symbol] —rotation, [symbol] —diode, [symbol] capacitor, κ—control, [symbol] —inductance, [symbol] —resistance. Thermopile coolers: [symbol] —cold junctions, [symbol] —hot junctions, [symbol] neutral and fixing elements, [symbol] —electric current supply. [symbol] —relief valve, U_{L}—output voltage, [symbol] —meters, [symbol] wiring.

Reference numerals 22,24,25,31 to 36, 40 to 42, 48, 50 to 54,62 to 64, 70 to 72, I to VI, valves, meters, control elements are universal conventional units used in present new proposal. Note: “si” and “se” are ionizers' and electrode ties' space steps, respectively. The regular, obvious elements and details are not shown for the reasonable clarity of the drawings.

### DETAILED DESCRIPTION OF THE INVENTION

The Air Flow Dynamo-Selfbooster (DS) includes an oval closed loop tunnel 20 with placed inside a multistage vane-axial fan 30 for cyclical impelling operative air flow, and a rotary seal slide-vane compressor 40 for periodic compensation of compacted by fan 30 portions of air flow.

The fan 30 works in self-series, at itself and for itself, thus rising the pressure and therefore the energy of compensated operative intense air flow.

The DS also includes: a combined set consisting of ionizers 40,seeding devices 23,24, and humidifier I—for keeping the proper electro-conductivity and magnetic permittivity of operative air flow inside the tunnel 20,
an array of inductors 43 for exciting electromagnetic fluxes generating,
an electrode structure 60,61,62,64 for induced currents collecting,
thermopile coolers 50,51A,51B for air flow and inductors, respectively,
noise-absorption unit 22, meters, thermostat 25, control,
electric energy self-supply and output devices.

FIGS. 1,2,3,6 illustrate the preferred embodiments of the typical DS and its basic units. In addition to said above elements, are shown:
fan housing 21, fan's elements 31 to 38, compressor's units 40A,41,42,
inductors 43 corresponding to the tunnel 20, humidifier's units II to VI.

FIG. 4 illustrates electro-functional scheme of the thermopile airflow cooler 50. Are shown: semiconductors 52A and 52B, converter 53, electrical currents, cold and hot junctions C,H, cold and hot gills 51,51e, respectively.

The electro-functional schemes of the thermopile inductors' coolers 51A, 51B are identical to the shown on FIG. 4.

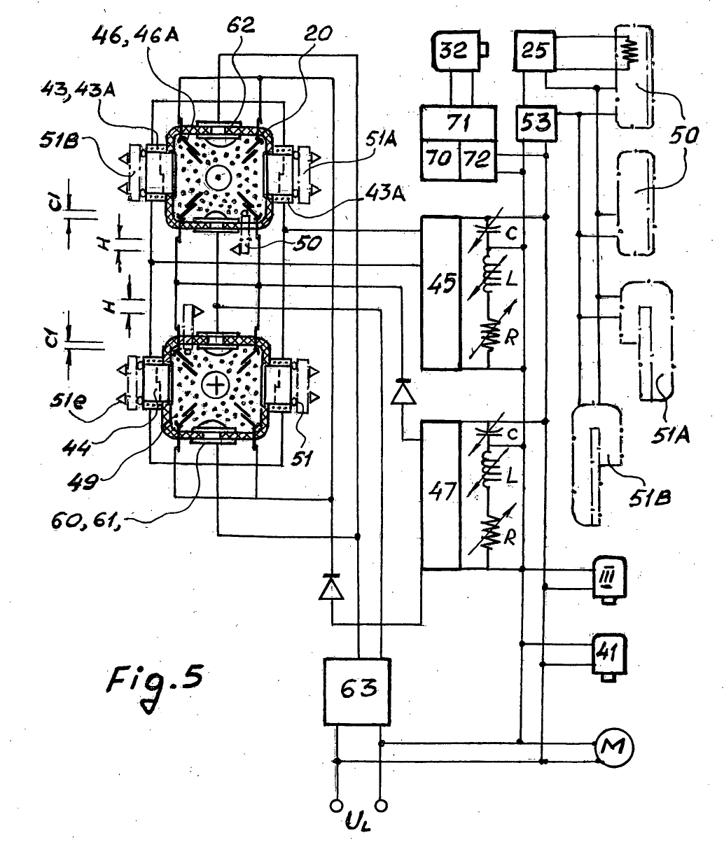

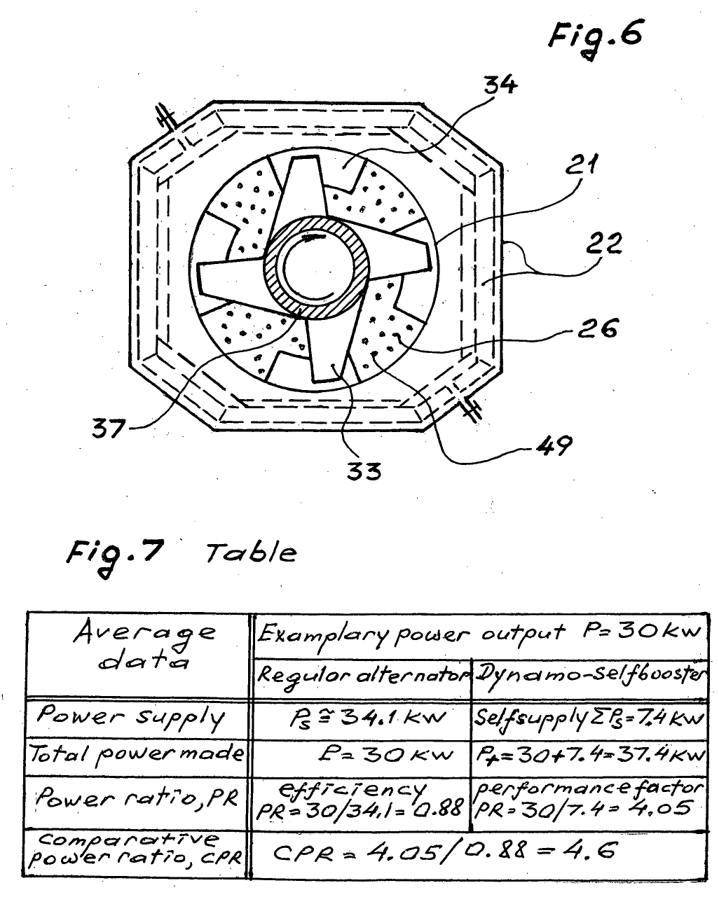

FIG. 5 illustrates fimctional electrical communications. In addition to the mentioned above, are shown:
energy self-supply units 70, 71, 72; oscillators 45, 47,
inductors' 43 solenoids 43A and cores 44 cooling elements,
arrangements of said ionizers, inductors, electrodes, coolers into tunnel 20,
operative air flow, electromagnetic fluxes, induced electric currents,
output transformer 63, wiring connections.

FIG. 7 illustrates average comparative data of an exemplary DS and a conventional alternator for equal output power. The efficiencies, performance factors, power ratios are shown.

### Operation

The Air Flow Dynamo-Selfbooster conducts pulse-inductive energy transfer from ionized intense air flow into output and self-supply electrical energy. The high level of air flow energy is provided by:
fan 30, impelling air in self-series, working at itself and for itself, and
compressor 40, periodically compensating the compacted by the fan 30 portions of operative airflow, thus supporting the proper total pressure.

Inductors 43, fed by oscillators 45, operate exciting electro-magnetic fluxes, constantly changing in opposite directions. The frequency of said oscillations can be tuned depending on general design.

Electrostatic ionizers 46 with needles 46A, fed by oscillators 47, provide pulse-ionization into operative air flow inside tunnel 20. The ionizers constantly attract and repel the grit-powder into oscillated suspended state with tuned frequencies. The suspended, oscillating, electro-statically charged inside air flow, the grit-powder, as a mix of magnetic and non-magnetic metallic seeds, contributes to the common levels of ionization, electro-conductivity, and magnetic permittivity of the operative intense air flow.

Optional operating of salt-water-humidifier I, depending on seeding grit-powder materials, can rise the levels of air flow ionization.

Electrode structure 60 to64 collects induced electric currents for the output transformer 63. Diodes 48 protect the ionizers 46 from induced currents.

Thermopile coolers 50,51A,51B keep the proper thermal conditions to the intense operative air flow and electromagnetic inductors.

1. An Air Flow Dynamo-Self-booster for inductive energy transfer from prepared, intense, cyclical, ionized operative air flow inside a closed loop tunnel with air propelling devices, array of electromagnetic inductors, thermopile coolers, and electric infrastructure, comprising:
a working in self-series multistage vane-axial fan for ionized seeded operative intense air flow cyclical impelling, and
a slide-vane rotary seal compressor for periodic compensations to the compacted by said fan portions of intense operative air flow.

2. The Dynamo-Self-booster of claim 1 includes a method wherein said fan impeller works inside closed loop tunnel in self-boosting manner with periodic air compensation, thus providing the cyclical pressure rising, air flow energy accumulation, self-supply, and high power ratio for the transferred energy output.

3. The Dynamo-Self-booster of claim wherein devices preparing the operative air flow to inductive interactions are combined and include:
a set of electrostatic ionizers with needles, and
a seeding mix metallic grit-powder unit, and
an optional operating salt-water humidifier,
all above in order to provide the proper electro-conductivity and magnetic permittivity of the operative air flow thus forming and supporting flow's inductive electromagnetic qualities.

4. The Dynamo-Self-booster of claim wherein said thermopile coolers include:
a) tunnel coolers for operative air flow and internal devices, and
b) side coolers for electro-magnetic inductors, and c) a thermostat.

5. The Dynamo-Self-booster of claim wherein said electric infrastructure includes:
a) oscillators for electro-magnetic inductors, and electro-static ionizers; both oscillators are tuned and adjusted at frequencies corresponding each other, and
b) a set of electrodes with nibs, plates, ties, bars—all for collecting the induced electric currents.

6. The Dynamo-Selfbooster of claim wherein said grit-powder, seeded into said air flow, includes mixed metallic magnetic and non-magnetic materials of high magnetic permittivity and high electro-conductivity, respectively.
